(19) United States
(12) Patent Application Publication
(10) Pub. No.: US 2009/0024325 A1
(43) Pub. Date: Jan. 22, 2009

(54) AINS enhanced survey instrument

(76) Inventor: Bruno M. Scherzinger, Richmond Hill (CA)

Correspondence Address: JAMES F KIRK, 16365 MARUFFA CIRCLE, HUNTINGTON BEACH, CA, 92649-2134, US

(21) Appl. No.: 11/879,941

(22) Filed: Jul. 19, 2007

(51) Int. Cl. G01C 21/00; G06F 19/00

(52) U.S. Cl. 702/5; 701/213; 701/214

(57) ABSTRACT

The invention comprises a survey pole having a survey pole bottom end, with a position-transducer coupled to a survey pole top end. A ground contact spike is on the bottom end. The survey pole uses an AINS as a combined tilt and heading sensor. The AINS provides heading and Euler angle outputs characterizing the tilt of the survey pole. The heading and Euler angle outputs are used by a computer and program to perform position transfers from a position-transducer at the pole top end to the GCZVI switch or spike on the ground using a set of position offset or transfer equations. The position-transducer is either a GNSS or an RTS serving as a position-transducer. The transfer of the position data from the position of the position-transducer provides the earth referenced or grid referenced position of the spike at the survey pole survey bottom end.

### BACKGROUND OF THE INVENTION AND RELATED ART

This application incorporates by reference U.S. Pat. No. 6,853,909 B2 for a “Walking Stick Navigator For Position Determination” which issued Feb. 8, 2005 and U.S. Pat. No. 6,834,234 B2 for an “AINS Land Surveyor System With Reprocessing, AINS-LSSRP” which issued on Dec. 24, 2004 in their entirety, each having a common inventor and assignee. U.S. Pat. No. 6,594,617 B2 for A Precise Pedometer Navigator issued on Jul. 15, 2003 has a common inventor and assignee and although less relevant than the preceding patents, is also incorporated by reference in its entirety. This application also incorporates by reference U.S. Pat. No. 5,512,905 for a “Survey Pole-Tilt Sensor For Surveyor Range Survey Pole”, issued on 30 Apr. 1996 to Mark E. Nichols et al. and assigned to Trimble Navigation Limited. U.S. Pat. Nos. 6,594,617 B2, 6,834,234 B2 and 6,853,909 B2 are assigned to Applanix Corporation, which is wholly owned by Trimble Navigation Limited.

The invention is an improvement of the invention taught in U.S. Pat. No. 6,853,909 B2 (referenced previously). The U.S. Pat. No. 6,853,909 patent teaches a walking stick navigator (WSN) that uses a GPS receiver as its primary position transducer. The subject invention; however, is a WSN that teaches the use of one or more of several position transducers used in precision land survey operations, such as the use of a locally ground referenced Global Navigation Satellite System (GNSS) receiver as a position transducer or a differential GPS as a position transducer, a conventional total station (CTS) position transducer and a robotic total station (RTS) position transducer in combination with an aided inertial navigation system (AINS) and the Euler angle outputs of an AINS.

The GNSS acronym typically refers to a complete positioning system that includes the space segment (satellites), ground segment (master control station and ground tracking stations) and user segments such as GNSS receivers, including rover and stationary reference receivers in a differential GNSS configuration.

A GNSS receiver comprises the electronics that process the RF signals captured by a GNSS antenna. The position solution computed by the GNSS receiver is the position of the antenna phase center. As used herein, a GNSS position transducer is a GNSS receiver and antenna combination. The term GNSS is meant to include in its scope, all possible configurations, including an integrated GNSS receiver/antenna module, the older generation combination of a receiver and separate antenna.

GNSS positioning as used herein is meant to include the following methods:

1. Autonomous: The GNSS receiver computes a position using standard broadcast information from the GNSS satellites without differential corrections. The expected accuracy is 5-15 meters.

2. Precise point positioning: The GNSS receiver receives precise satellite orbit and clock information via a satellite link and computes a non-differential position solution to obtain an expected accuracy 10-30 cm.

3. Differential GNSS: The GNSS receiver receives differential corrections from a differential GNSS reference receiver or a Virtual Reference Station (VRS) server via a radio modem or cellular modem link, and computes a differential GNSS position solution having an expected accuracy of 0.5-1.0 meters.

4. Real-time kinematic (RTK) GNSS: The GNSS receiver receives synchronous carrier phase data or differential carrier phase data from a reference receiver or VRS server via a radio modem or cellular modem link. The GNSS receiver then computes a carrier phase interferometry position solution with an expected accuracy of 1-5 cm accuracy. A key step in this positioning mode is resolution of unknown integer cycles in the differential phase ranges so that these become precise differential phase ranges with a few millimeters accuracy. This is the standard mode for surveying with a GNSS survey instrument.

The subject invention is an improvement of the invention taught in U.S. Pat. No. 5,512,905 (referenced previously). The U.S. Pat. No. 5,512,905 patent teaches a means for the transfer of the position of the position-transducer from its location on a survey pole through the offset distances (North, East and Down) to the ground contact position (GCP), thereby correcting the position of the position-transducer position to be the position of the spike at the GCP using a generic two-axis tilt sensor and a separate direction sensor. The subject invention, on the other hand, uses Euler angle outputs from an aided inertial navigation system (AINS) available on a survey pole. At the time of this disclosure, the cost of an AINS that has a sufficient orientation or Euler angle accuracy to achieve sub-centimeter relative position error over one meter is sufficiently high to make the AINS strictly as a three-axis tilt sensor a prohibitively expensive solution. However, an AINS that is an existing component of a GNSS-inertial-enhanced (GIE) survey instrument such as that described in U.S. Pat. No. 6,853,909 (referenced previously), provides the required platform Euler angle signals at virtually no additional cost. A GIE survey instrument will therefore provide the orientation angle signals required for tilt compensation, position transfer and the platform Euler angle signals necessary for the correction process shown in U.S. Pat. No. 5,512,905 (referenced previously).

### FIELD OF THE INVENTION

The subject invention AINS Enhanced Survey Instrument relates to the field of modern survey instruments that use GNSS receivers, inertial navigation systems and total stations. The present system is a survey instrument formed on a survey pole equipped with a ground contact spike, a ground contact zero-velocity indicator (GCZVI) switch, a position-transducer and an aided inertial navigation system (AINS). The position-transducer used on an AINS Enhanced Survey Instrument is typically a GNSS receiver, a precise locally referenced conventional total station (CTS) system or a robotic total station (RTS) system. The AINS Enhanced Survey Instrument also has available an on-board AINS system for use as a backup navigation source in the event of loss of signals from the position-transducer.

On detection of loss of the position-transducer, the subject invention is typically programmed to revert to use of the AINS for service as a dead reckoning navigation unit. The position-transducer uses on-board AINS as a backup navigational reference for periods during which the primary navigational signals from the position-transducer are lost. Back-up use with the AINS makes it possible to survey areas where position-transducer signals may be temporarily interrupted or missing for time intervals of varying duration or indefinitely due, for example, to a building obstruction, operation inside a building, cave or tunnel, tree foliage and/or a dense tree canopy. The AINS that is used is normally aided with a radio positioning system such as a GNSS receiver but upon loss of GNSS position aiding as a result of signal blockage, the AINS is typically programmed to automatically enter into a dead reckoning navigation mode.

The AINS provides 3-axis tilt angles and the heading of the survey pole when carried by a surveyor. The invention computes the relative position offset of the ground contact point with respect to the position-transducer position using the 3-axis tilt angles and the known distance between the position transducer and the ground contact spike. It then transfers the position coordinates of the position-transducer using the previously computed relative position offset to obtain the ground contact spike position. A computer executes a program that samples the Euler angle outputs of the AINS and the calibrated survey pole length to continually compute the coordinate offset distances or offset angles in latitude and longitude with respect to the position of the position-transducer for use in correcting the position of the spike, thereby eliminating any requirement for precise levelling of the survey pole.

The tilt-direction sensor package in the earlier embodiment of the invention claimed in U.S. Pat. No. 5,512,905 (referenced previously) is shown to be a two-axis electronic bubble level plus a magnetic compass. The invention described herein uses the Euler angle outputs of an AINS to supply the three orientation angles of (roll-pitch-heading) that describe the tilt of the survey pole plus the known or measured separation of the position-transducer from the GCP, thereby making it possible for a program to compute the relative position of the GCP or spike with respect to the position-transducer using a lever-arm calculation, and to then transfer the position-transducer coordinates to the GCP corrected by the offset angles related to the survey pole length and the corresponding roll-pitch-heading in time synchronization with the position of the position-transducer outputs.

The subject precision land survey instrument uses a GNSS receiver, a CTS transducer, or an RTS transducer on a pole top with a ground contact spike equipped with a GCZVI switch at the survey pole base. The CTS and the RTS are well-known survey instruments that use laser ranging to measure relative positions with respect to the instrument position. The CTS contains a laser light source and sighting telescope that are mounted on a 2-axis gimbal with shaft encoders that measure the gimbal angles. A CTS or RTS position-transducer contains a retro-reflector or prism that returns a laser beam transmitted by a CTS or RTS.

A CTS requires a two-person survey team to operate the instrument. One person holds the survey pole in a vertical position on a point to be surveyed using a bubble level so that the retro-reflector is directly over the point to be surveyed. The second person operates the CTS by manually aiming the laser beam onto the retro-reflector by means of the sighting telescope, and then acquiring the gimbal shaft angles and laser range to the retro-reflector. The shaft angles and range comprise the relative polar coordinates (azimuth, inclination and range) of the retro-reflector with respect to the CTS position. The absolute position of the retro-reflector is the position of the CTS plus the relative position of the retro-reflector with respect to the CTS position. The position of the point to be surveyed is then the position of the retro-reflector minus the known height of the retro-reflector with respect to the ground contact spike when the pole is vertical.

An RTS includes in addition servo motors on the gimbal axes and a servomechanism controller for tracking the retro-reflector. The RTS tracks the retro-reflector automatically and measures the relative polar coordinates of the survey pole. It computes the position of the retro-reflector from these data and transmits the position solution to a data recording device attached to the survey pole. The process proceeds continuously at a sampling rate of between 1 and 1000 position fixes per second, or asynchronously as the position-transducer sends a request to the RTS for a position fix. The operator holding the survey pole then records the position of the survey pole via a data collector having a communication channel to the position-transducer by a means such as a Bluetooth, 802.11 or a simple data cable and data protocol. The RTS system reduces the survey team to a single surveyor but continues to require the surveyor to align the survey pole into a near vertical orientation. The single surveyor is thereby able to rapidly and efficiently survey multiple points of interest.

In the case of a GNSS receiver equipped survey instrument, the position-transducer is a combined GNSS receiver and antenna module. The GNSS receiver equipped surveyor computes the position of the antenna phase center using precise differential GNSS technology with every epoch being in a range 0.1-1 seconds. Precise differential GNSS positioning is a well-established methodology for precise surveying. It uses a single reference receiver at a known location or a network of reference receivers to provide differential correction signals that allow precise positioning algorithms implemented in the GNSS receiver to achieve sub-decimeter position accuracies. One such methodology called real-time-kinematic (RTK) positioning uses phase interferometry between the roving GNSS receiver and the reference GNSS receiver to obtain position accuracies on the order of a few centimeters. Another such methodology called precise point positioning (PPP) uses precise GNSS satellite orbit and clock information to generate position accuracies on the order of 10-20 centimeters without a reference receiver. A real-time implementation of PPP uses satellite-based communication channels to distribute the precise satellite orbit and clock information. An example of such a space-based augmentation service (SBAS) is the Omnistar HP service provided by Fugro N.V.

In the absence of the subject invention, the operator is required to place the ground contact spike on the point on the ground to be surveyed and then hold the survey pole vertical and stationary for a predetermined minimum period. The period can extend to exceed a few seconds. The operator uses an attached bubble level to guide the survey pole to a vertical position within a small tolerance. The position generated by the position-transducer is then transferred to the position of the GCP as a strictly vertical position adjustment or projection using the known separation of the transducer and the GCP. The levelling and stationary occupation procedure typically consumes 10-30 seconds per surveyed point, and as such is a significant component of the total time required to survey multiple points of interest. If for example, a particular survey job requires 100 points to be surveyed, then the operator consumes 15 to 50 minutes in the levelling procedure.

The Trimble R8 GNSS Surveyor is an example of a GNSS survey instrument that has a survey pole with a GNSS receiver module at the pole top of the survey pole and a simple spike at the bottom end. A hand-held control and data logger unit (CDU) is alternatively held by the surveyor or mounted on the survey pole at the approximate midpoint. A battery pack that powers the unit is located in the GNSS receiver module. The surveyor walks to each point to be surveyed, places the spike at the bottom end on the survey pole on the point to be surveyed, brings the survey pole to a vertical position using the attached bubble level, and either records a position computed by the receiver to the CDU, or “occupies” the point for a period of time during which the GNSS receiver module computes an averaged position that the CDU records.

A GNSS, CTS or RTS AINS Enhanced Survey Instrument typically has the “look and feel” of a Walking Stick Navigator (WSN) survey instrument. The surveyor walks to each point to be surveyed, places the spike at the bottom end of the survey pole on the point to be surveyed and records a measured position. A position transducer at the survey pole top end measures the position of the pole top. The measured position is then compensated for offset due to the tilt and heading of the pole using Euler angle information from the AINS. The compensated position is then transferred for use as the surveyed position. The compensation step is completed without having to bring the survey pole to an exact level position. The only additional field procedure that a surveyor must conduct is to manipulate the AINS Enhanced Survey Instrument like an AINS-equipped WSN when primary navigation signals from the position-transducer system drop out.

The AINS Enhanced Survey Instrument provides dead reckoning navigation upon the loss of position data from the position-transducer as can occur inside or between buildings, caves, tunnels or in heavy forested areas. The surveyor walks a survey trajectory and uses the AINS Enhanced Survey Instrument as a WSN to survey positions along the trajectory with the AINS Enhanced Survey Instrument navigating in a dead-reckoning mode with as little position drift as possible.

### SUMMARY OF THE INVENTION

This invention survey instrument comprises a survey pole, a position-transducer and an aided INS (AINS) that uses the AINS to measure the 3-axis Euler angles (also called the 2-axis tilt angles and the heading angle) of a survey pole for the purpose of computing the position of the bottom end of the pole as it touches a point on the ground without requiring the operator to manually level or to orient the survey pole or to direct a reference line on the survey pole to point in a particular direction, such as North, or to hold it stationary while acquiring the survey data.

A positioning measurement transducer such as a GNSS receiver or a reflective prism for a CTS or an RTS is mounted at the survey pole top end. An AINS is mounted to the survey pole base. A ground spike mounted to the survey pole bottom end. A GCZVI switch closure as the ground spike contacts the ground to signal the AINS that the ground velocities are zero. A plunger compresses the GCZVI switch slightly as the ground spike contacts the ground and the transfer of the GCZVI switch is coupled electrically to an on-board computer signalling the AINS that the velocities at the ground contact point in the North, East and Down directions are zero.

### BRIEF DESCRIPTION OF THE DRAWINGS

FIG. 1 is a block diagram for an AINS architecture;

FIG. 2a is a schematic three dimensional depiction of the position projection and vectors for the transfer of the position of a position-transducer to the location of a spike;

FIG. 2b is a schematic three dimensional depiction of the position projection and vectors for the transfer of the position of a GNSS position-transducer corrected by a ground referenced GNSS receiver located at H, to the location of a spike, the combination showing use of an AINS;

FIG. 2c is a schematic three dimensional depiction of the position projection and vectors for the transfer of the position of an RTSR position-transducer corrected by an RTS receiver located at H, to the location of a spike, the combination showing use of an AINS;

FIG. 3a is a schematic of an embodiment “A” of a GIE survey instrument with a GNSS-INS module at the pole top and a GCZVI switch at the survey pole base;

FIG. 3b is a schematic of an embodiment “B” of a GIE survey instrument showing a GNSS module at the pole top and an AINS with a GCZVI switch at the survey pole base;

FIG. 4a is a schematic of an embodiment “C” of an RIE survey instrument with an RTSR-INS at the pole top and with a GCZVI switch at the survey pole base;

FIG. 4b is a schematic of an embodiment “D” of an RIE survey instrument with an RTSR at the pole top, an with an AINS and a GCZVI switch at the survey pole base;

FIG. 5 is a flowchart depicting the steps in a position transfer algorithm; and,

Table 1 appears in the specification and shows the sequence of events in flow table format that characterize some of the process steps in the operation of the invention.

### DETAILED DESCRIPTION OF THE INVENTION

Aided Inertial Navigation System (AINS)

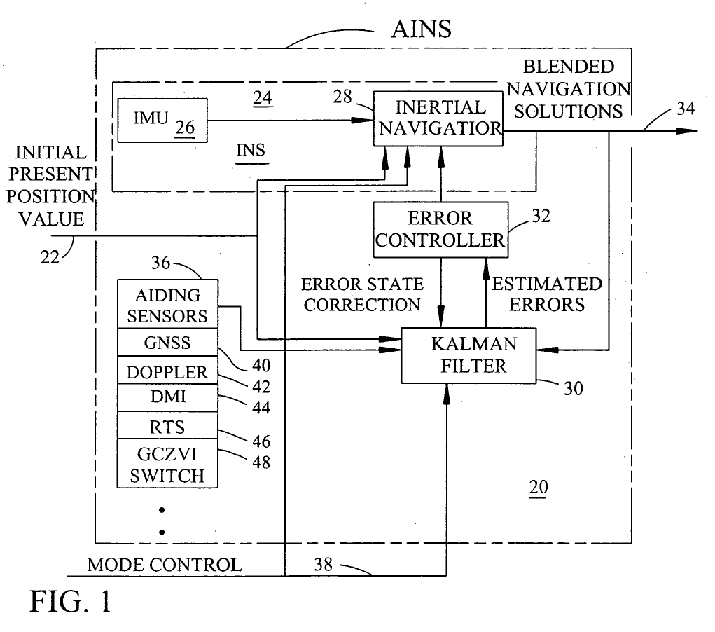

FIG. 1 is a block diagram that shows the architecture of a generic aided inertial navigation system (AINS) represented by phantom block 20. The AINS 20 is provided with an initial present position input from a keyboard or other input device (not shown) on a signal line indicated as the INITIAL PRESENT POSITION VALUE signal path 22. Phantom block 24 represents and contains the elements of an inertial navigation system (INS). The INS 24 block represent an inertial measurement unit (IMU) 26 and block 28 to represent an INERTIAL NAVIGATOR 28. The INERTIAL NAVIGATOR 28 performs alignment and inertial navigation computational functions using data from the IMU 26. FIG. 1 shows the IMU 26 and the INERTIAL NAVIGATOR 28 coupled together to perform the function of the INS 24.

Block 30 represents a KALMAN FILTER. Block 32 represents an ERROR CONTROLLER function that estimates INS 24 errors using inputs from the KALMAN FILTER 30 and provides outputs to the INERTIAL NAVIGATOR 28 to correct the INS 24 output to provide a blended navigation solution from the INERTIAL NAVIGATOR 28 on the BLENDED NAVIGATION SOLUTIONS output bus 34. A MODE CONTROL legend appears on signal path 38. The MODE CONTROL signal path 38 schematically represents a signal path for controlling the operating mode of INS 24. By way of example, at initial power up, the operator would select the alignment mode. After alignment, the operator would move the system from the alignment mode to the navigate mode.

Examples of aiding sensors, some of which may or may not be present within AIDING SENSORS block 36, include one or more GNSS receivers represented by the GNSS receiver block 40, a Doppler radar providing velocity data represented by the DOPPLER block 42, or an odometer or distance measuring indicator or instrument represented by the DMI 44 block. Signals from an RTS are represented by block 46. The signals from a GCZVI are represented by block 48. Inputs to the KALMAN FILTER 30 from one or more aiding sensors from sensors within the AIDING SENSORS block 36 enable the Kalman Filter and the error controller to continually correct the outputs, and gyro biases of the INS 24 to obtain improved accuracy.

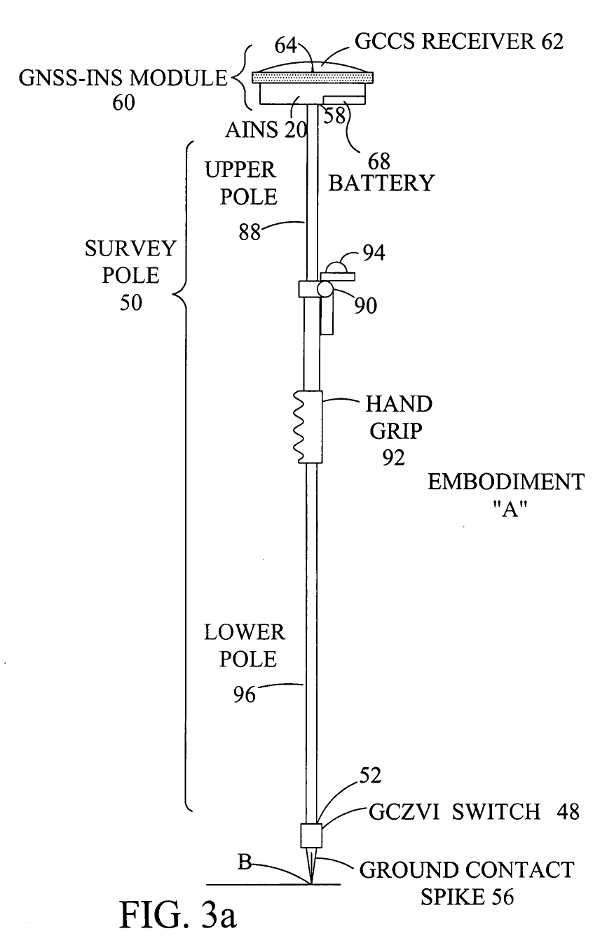

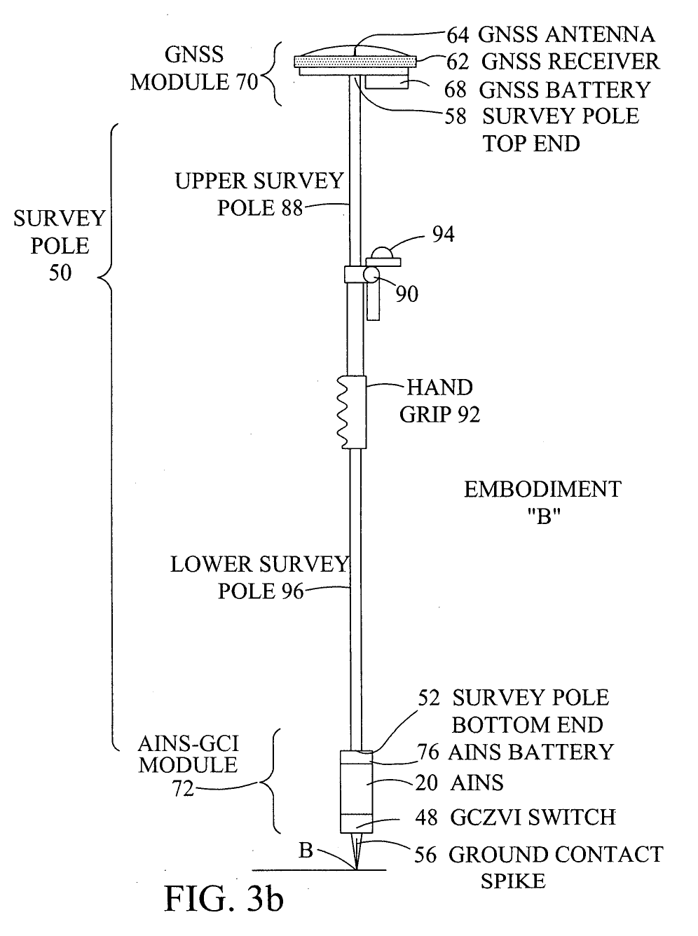

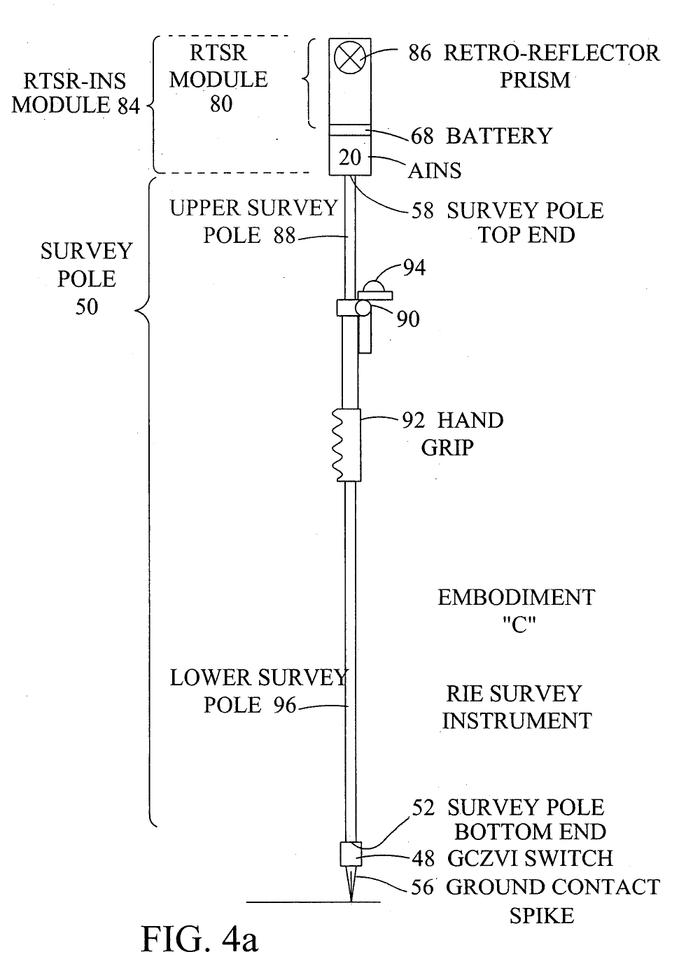

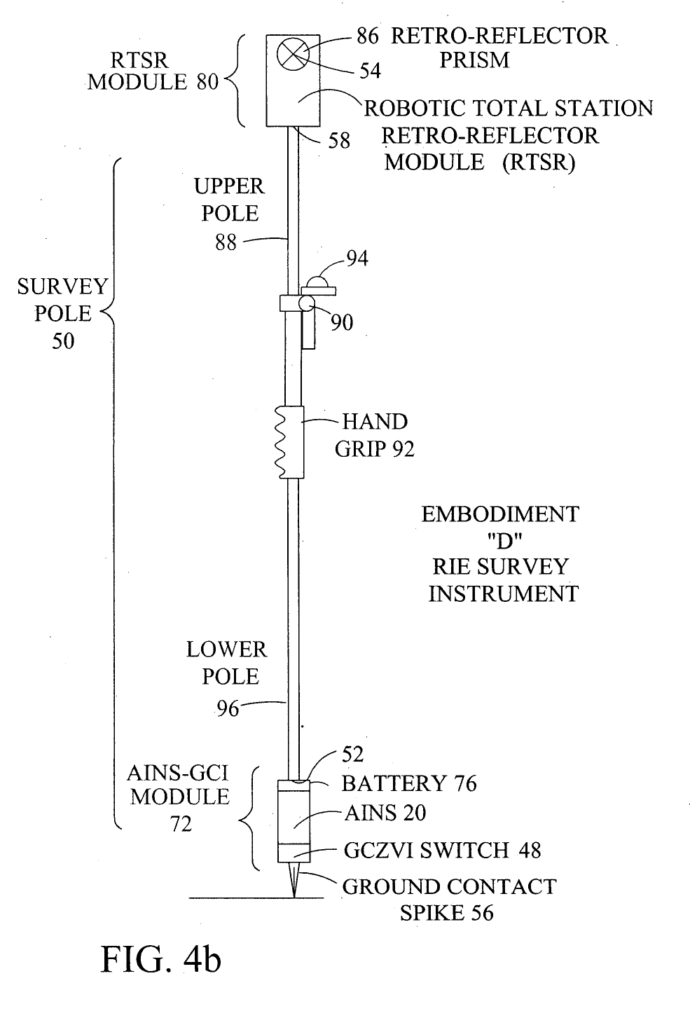

The U.S. Global Positioning System (GPS) and Russian GLONASS are the currently available GNSS systems. The U.S. GPS is the system that is most widely used for navigation and survey applications. The European Galileo system is scheduled to become an alternate available GNSS within the next 10 years and China is likely to produce a competing GNSS within the foreseeable future.
Embodiments of the invention AINS Enhanced Survey Instrument (AESI) are shown schematically in FIGS. 3b and 4b in which each of the depicted embodiments characterized use an AINS 20 and at least one GNSS receivers 40, either singly or in combination with a Robotic Total Station (RTS) 46, and an input from a GCZVI switch 48. In the embodiments shown, the AINS is shown coupled to the survey pole adjacent to or within a few centimeters (a distance of from 0-5 centimeters) of the bottom end.

The AIDING SENSORS block 36 represent any sensor that provides navigation information that is statistically independent of the inertial navigation solution that the INS 24 generates. The KALMAN FILTER 30 and the ERROR CONTROLLER 32 process and provide corrections for the INERTIAL NAVIGATOR 28 which periodically outputs a sequence of corrected or blended present position solutions in real time on THE BLENDED NAVIGATION SOLUTIONS output bus 34.

The INERTIAL NAVIGATOR 28 uses a digital computer and navigational software for processing signals from the IMU 26. The IU comprises a triad of accelerometers (not shown) that measure total acceleration, and a triad of gyros (not shown) that measure total angular rate. The IMU 26 also provides process and interface electronics (also not shown) that convert and output inertial acceleration and angular rate signals in a digital format. The INERTIAL NAVIGATOR 28 mechanizes Newton's equations of motion using the aforementioned navigational software and digital computer (not shown).

The INS 24 initially performs a ground alignment after which it transforms signal data from its package or vehicle navigation coordinate frame into a fixed and earth-referenced coordinate system, such as a North, East and Down (NED) referenced system. A typical ground alignment or gyro-compassing alignment requires the INS to be stationary for 5-15 minutes and to have its latitude for use as an input. During the alignment interval, the INS uses its accelerometers to establish the direction of the gravity vector that defines the Down direction and the 2-axis tilt angles of the IMU with respect to the Down direction. With the latitude of the present position known and with the latitude input as data, the INERTIAL NAVIGATOR 28 then calculates the horizontal component of rotational rate that a horizontal North pointing referenced axis would experience. The alignment process adjusts the body-to-earth direction cosine matrix (DCM) as required to match the measured roll rate of the transformed North pointing body axis to the calculated roll rate for the North pointing axis. Accelerometer and gyro axis rates are thereafter transformed into earth referenced data using the adjusted DCM. In some mechanizations, the horizontal North pointing axis is aligned to a heading other than North and East and the heading offset angle is called the wander angle.

The IMU 26 generates incremental velocities and incremental angles at the IMU sampling rate, typically 50 to 1000 samples per second. The corresponding IMU sampling time interval is the inverse of the IMU sampling rate, typically 1/50 to 1/1000 seconds. The incremental velocities are obtained from outputs of the IMU accelerometers that are integrated over the IMU sampling time interval. The incremental angles are the angular rates from the IMU gyros integrated over the IMU sampling time interval. At the conclusion of the alignment mode, the INERTIAL NAVIGATOR 28 receives the present position of the system as data and enters the free inertial mode after which the system uses the sampled inertial data from the IMU 26 and computes the current IMU present position (typically latitude, longitude, altitude), velocity (typically North, East and Down components) and orientation (roll, pitch and heading) at the IMU sampling rate. The MODE CONTROL signal path 38 represents a path for management and data signals to be coupled to the AINS 20 from an external source such as a keyboard or a ground switch (not shown).

The KALMAN FILTER 30 is a recursive minimum-variance estimation algorithm that computes an estimate of the system's state vector based on actual and constructed measurements. The measurements typically comprise computed differences between the inertial navigation solution elements and corresponding data elements from the aiding sensors. For example, the computed inertial-GNSS position difference measurement comprises the differences between the respective latitudes and longitudes computed by the INERTIAL NAVIGATOR 28 and the latitudes and longitudes measured and reported by a GNSS 40 receiver. The true positions cancel in the differences, so that the differences in the position errors remain. A Kalman filter designed for use with an INS 24 and AIDING SENSORS 36 that will typically estimate the errors in the INS 24 and aiding sensors. The INS 24 errors typically comprise the following: INS position errors, INS velocity errors, INS platform misalignment errors, accelerometer biases and gyro biases. Aiding sensor errors can include the following: GNSS North, East and Down position errors, GNSS carrier phase ambiguities and a DMI scale factor error.

The ERROR CONTROLLER 32 computes a vector of resets from the INS error estimates generated by the KALMAN FILTER 30 and applies these to the inertial navigator integration processes, thereby regulating the inertial navigator errors in a closed error control loop. The inertial navigator errors are thereby continuously regulated and hence maintained at significantly smaller magnitudes than might be obtained without the benefit of Kalman filtering.

### AINS Land Surveyor

An AINS land surveyor is any embodiment of an AINS carried by a surveyor for the purpose of measuring position fixes. The AINS land surveyor does not require access to the sky, as does a GNSS receiver, and hence can be operated under a dense tree canopy, underground or inside buildings, in scenarios where a GNSS receiver cannot function. An example of a high performance AINS land surveyor is the Applanix POS LS. This is a backpack-borne instrument design for conducting seismic surveys. It allows a single surveyor to walk and establish surveyed positions among the trees in a forest without requiring trees to be cut to establish a survey lane, as does a survey conducted with a GNSS survey instrument, a laser theodolite or an RTS.

A current embodiment of an AINS land surveyor such as the POS LS requires the surveyor to bring the AINS 20 to a complete rest periodically, typically every 1-2 minutes, for a period of 15-30 seconds. This is called a zero-velocity update (ZUPT). The Kalman integration filter uses these zero-velocity observations to zero the INS velocity error and partially calibrate inertial sensor errors. The position error drift with periodic ZUPT's is on the order of 1-2 meters per kilometer. In an alternative embodiment, the AINS detects and processes the ZUPT automatically using the INS velocity. In the alternative, the surveyor identifies a ZUPT by way of a signal to the INS from a manually operated switch or from the closure of the GCZVI switch 48 shown in FIGS. 3a-4b. The GCZVI switch is coupled to the survey pole 50 at the pole base or survey pole bottom end 52.

Automatic ZUPT detection can be unreliable because it must include tolerance for INS velocity drift between ZUPT's, typically on the order of a few centimeters per second. An actual ZUPT will not be detected when the surveyor has come to a stop and residual velocity errors or gyro bias errors exceed the tolerance limits for ZUPT detection. Having the surveyor manually identify a zero-velocity condition when he stops for any reason reduces the possibility of an automatic system failing to detect a ZUPT; however, the possibility of a surveyor failing to initiate a ZUPT signal has to be considered. In either case, an incorrectly identified ZUPT processed by the AINS 20 KALMAN FILTER 30 can cause the AINS KALMAN FILTER to develop inaccurate INS error estimates and lead to a performance failure in the AINS land surveyor. The use of a signal from GCVZI SWITCH 48 eliminates the possibility of velocity error tolerances being excessive or a surveyor failing to manually signal a ZUPT.

Notation

The following notation is used in the following equations and in other related art so it is included here by way of explanation and for reference. A term such as \vec{x} denotes a vector with no specific reference frame of resolution. On the other hand, the term \vec{x}^{a} denotes a vector resolved in a coordinate frame called the a-frame. For convenience, all coordinate frames are right-handed orthogonal frames. This implies that the X-Y-Z axes form an orthogonal triad in the forward, right and down directions. Typical coordinate frames of interest are the geographic frame (g-frame) whose principal axes coincide with the North, East and Down directions, and the inertial sensor body frame (b-frame), whose principal axes coincide with the input axes of the inertial sensors.

Subscripts on vectors are used to indicate a particular property or identification of the vector. For example, l̅_{S-G}^{a} denotes the lever arm vector resolved in the a-frame from the inertial sensor frame origin S to a GNSS antenna phase center G.

Matrices are designated with capital letters. The term Cₐ^{b} denotes a direction cosine matrix (DCM) that transforms a vector from the a-frame to the b-frame, i.e., \vec{x}^{\vec{x}}^{^{b}}=Cₐ^{b}\vec{x}^{a}.

Time dependency is not characterized in the equations that follow; however, if it were, it would be convenient to characterize the time dependency of a quantity with round brackets around a time variable or index. For example, Cₐ^{b}(t₁) denotes the value of the DCM at time t₁.

An increment of a variable is indicated with the capital Greek letter delta. For example, Δ\vec{x} denotes the increment of the vector \vec{x} over a predefined time interval. An error in a variable is indicated with the symbol δ. For example, δ\vec{x} denotes the error in the vector \vec{x}. δΔ\vec{x} denotes the error in the increment of \vec{x} over a predefined time interval.

The terms northing and easting refer to Universal Transverse Mercator (UTM) Coordinates. The system divides the surface of the earth up into a grid. The grid is divided into rectangular zones arrayed in columns and rows. A zone will be in a column having a zone number and in a row having a zone designator. A zone number and designator specify the map of a zone. A point in a zone is located by measuring distances in meters from south to north. Such a measurement in a northerly direction is referred to as northing. Such a measurement in an easterly direction is referred to as easting.

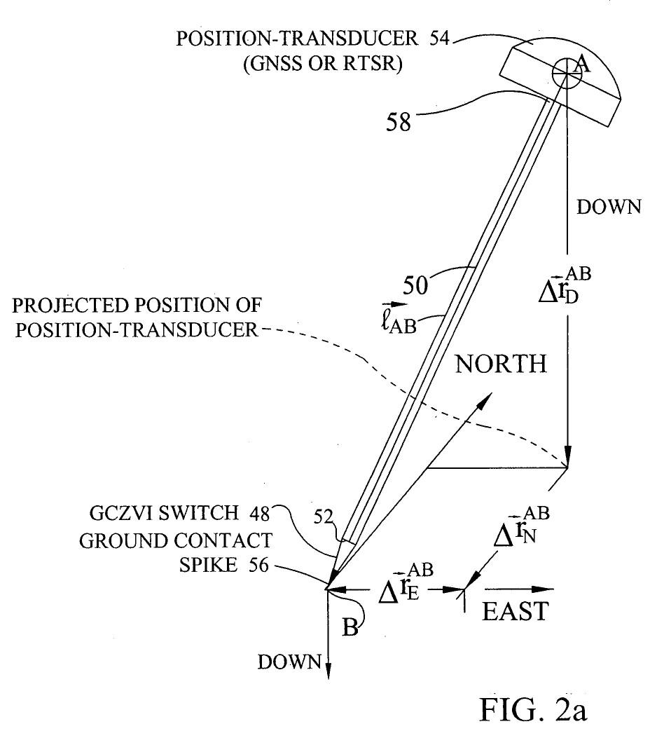

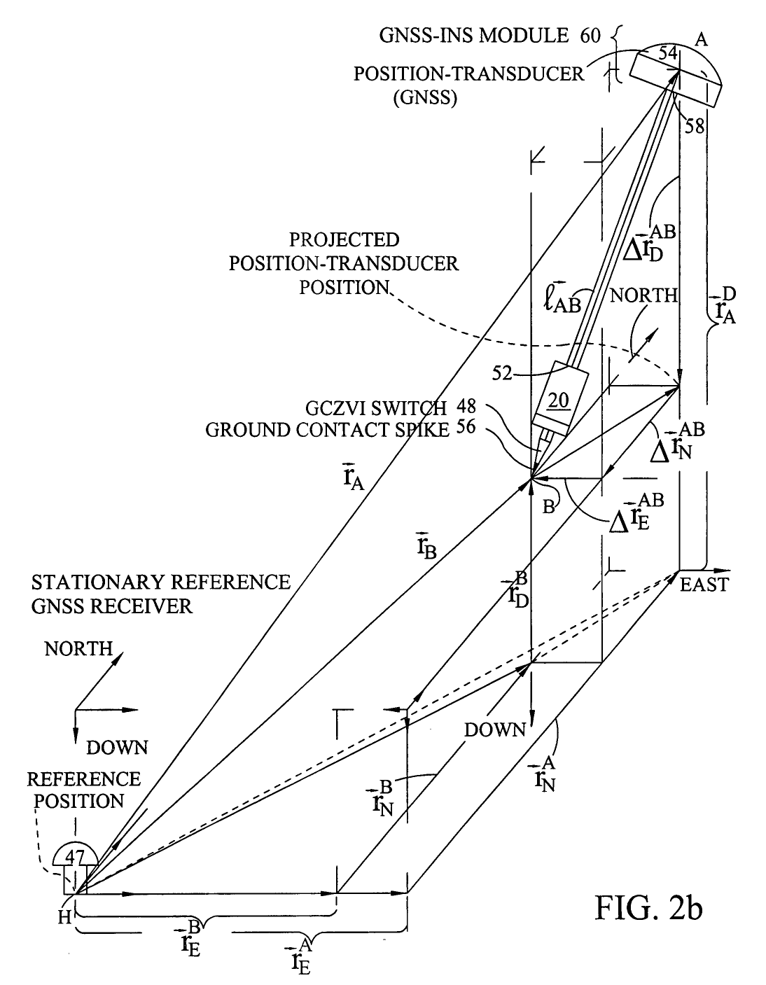

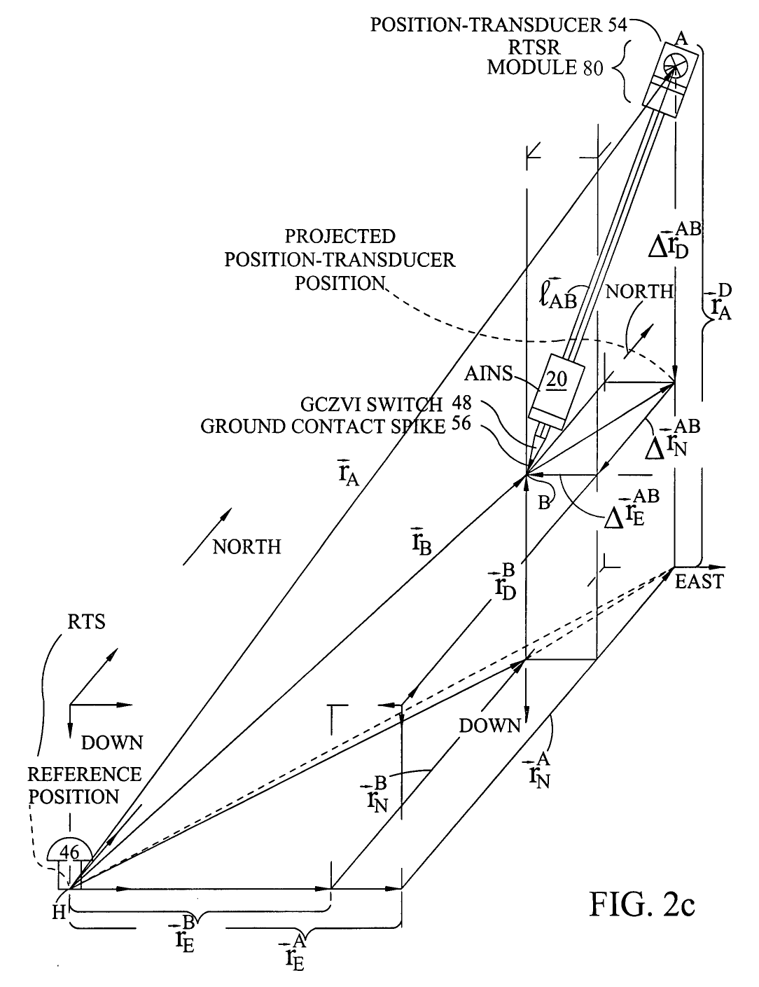

B as depicted on FIG. 2a at the ground spike 56 for all reasonable tilt angles of the survey pole 50. FIG. 2a schematically depicts a random tilt angle. The length of the survey pole 50 is l̅_{AB}^{b}. The length of l̅_{AB}^{b} is determined during a calibration that is performed when the system is manufactured at the factory. The survey instrument computes the coordinates of the GROUND CONTACT SPIKE 56 on the ground at position B by adding the vector offsets required to translate the position of the POSITION-TRANSDUCER 54 to the ground at position B.

As shown in FIG. 2a, three vector offset distances are measured from position A, at the position transducer, to position B, on the ground at the point of the spike. The superscript AB indicates the path from A to B being characterized. The subscripts used are D for down, N for a nothing direction change and E for Easting direction change. The first vector component starting from location A in a downward direction is Δ\vec{r}_{D}^{AB}. The second vector traversing in northing direction from the tip of the previous vector is Δ\vec{r}_{N}^{AB} and the final component extending from the tip of the previous vector n an easting direction to point B is Δ\vec{r}_{E}^{AB}. The method for computing the values of these vector components using direction cosines and the Euler angle outputs from the AINS in linear and angular equivalents is discussed later in this disclosure. After calculation, these vector offsets are added to the position of the position transducer 54 at position A to obtain the position of the spike at position B. The process of calculating and correcting the position at A to be a position of the spike at B is achieved without the necessity of erecting the survey pole into a vertical position and without stopping the motion of the pole.

FIG. 2b extends FIG. 2a to show a survey pole 50 now supporting an AINS 20 above the GCZVI switch 48, the combination being integrated and coupled to the survey pole bottom end 52 above spike 56.

FIG. 2b also shows a stationary reference GNSS receiver 47 at location H for providing correction signals from a single GNSS reference receiver at a precisely known location, such as location H, via a communication channel such as a radio modem or a cellular telephone network to GNSS receivers within its effective range. Alternatively, the GNSS reference receiver 47 represents a virtual reference receiver that a VRS implements. FIG. 2b provides a three dimensional schematic depiction of the position of the position transducer 54 and the vectors Δ\vec{r}_{D}^{AB}, Δ\vec{r}_{N}^{AB} and Δ\vec{r}_{E}^{AB} used to transfer the position of the GNSS position-transducer 54 at A to position B at the spike. vectors \vec{r}_{E}^{A}, \vec{r}_{N}^{A} and \vec{r}_{A}^{D} are shown extending from the known position of the stationary reference differential GNSS receiver position at H to A. The position of the GNSS transducer 54 is corrected with correction information from the GNSS reference receiver 47 at H. The precise position of the GNSS reference receiver 47 is known. vectors \vec{r}_{E}^{B}, \vec{r}_{N}^{B} and \vec{r}_{D}^{B} are then calculated by correcting the vectors \vec{r}_{E}^{A}, \vec{r}_{N}^{A} and \vec{r}_{A}^{D} with the heading and tilt vectors Δ\vec{r}_{D}^{AB}, Δ\vec{r}_{N}^{AB} and Δ\vec{r}_{E}^{AB} to obtain the position of point B with respect to the precise position of H.

The GNSS receiver 62 in each of the embodiments A and B in FIGS. 2a and 3b respectively computes a precise GNSS position using GNSS correction signals obtained from the reference differential GNSS receiver 47.

FIG. 2c is a schematic three dimensional depiction of the position projection and vectors for the transfer of the position of an RTSR position-transducer in the RTSR module 80 such as a retro-reflector prism 86 obtain the position of the ground contact spike 56 at position B. The position of the position transducer in module 80 is measured by an RTS 46 at position H and transmitted to the RTSR module 80, which supplies vectors \vec{r}_{E}^{A}, \vec{r}_{N}^{A} and \vec{r}_{A}^{D} shown in FIG. 2c. AINS enabled measurements then permit the computation of tilt vectors Δ\vec{ro}_{D}^{AB}, Δ\vec{r}_{N}^{AB} and Δ\vec{r}_{E}^{AB} which are then combined with the measured vectors \vec{r}_{E}^{A}, \vec{r}_{N}^{A} and \vec{r}_{A}^{D} to obtain vectors \vec{r}_{E}^{B}, \vec{r}_{N}^{B} and \vec{r}_{D}^{B}. The position of the spike 56 is then obtained as the position of the RTS receiver 46 at H plus the vectors \vec{r}_{E}^{B}, \vec{r}_{N}^{B} and \vec{r}_{D}^{B}.

GIE Survey Instrument

FIGS. 3a and 3b show EMBODIMENT A and EMBODIMENT B as respective alternative embodiments of a GNSS Inertial Enhanced (GIE) survey instrument. In the following paragraphs, use of the term “AINS” 20 shall be understood by the reader to include the characterization of an INERTIAL NAVIGATOR 28 with an IMU 26 as described in connection with FIG. 1 above and the processing means to implement the AINS algorithm described above in connection with FIG. 1.

FIG. 3a shows EMBODIMENT A of the invention. A GNSS-INS module 60 containing an integrated AINS 20 under the GNSS antenna is mounted at the survey pole top end 58 of the survey pole 50. A GCZVI SWITCH 48 is shown coupled to the survey pole base or survey pole bottom end 52. The GCZVI SWITCH 48 provides a switch closure (not shown) in response to the ground contact spike 56 making contact with the ground. The AINS 20 within the GNSS-INS module 60 is electrically coupled to receive signals from the GNSS receiver 62 in the GNSS-INS module 60. A ground contact signal from the GCZVI switch 48 is coupled to the AINS 20 by electrical, optical, mechanical or acoustical means to transfer a ground contact signal as the ground contact spike 56 contacts the ground. The GCZVI SWITCH 48 is shown mechanically coupled to a ground contact spike 56. The GCZVI SWITCH 48 is above the ground contact spike 56. Power for the GIE survey instrument EMBODIMENT A is supplied by a battery pack such as BATTERY 68 coupled to the GNSS-INS module 60. The embodiments of FIGS. 3a and 3b differ from each other in the placement of the AINS 20.

FIG. 3b shows EMBODIMENT B of the invention. A GNSS module 70 is positioned on the survey pole top end 58 of survey pole 50. AINS 20 is shown integrated into an AINS-GCI module 72 at the survey pole bottom end 52. The AINS-GCI module 72 contains a GCZVI SWITCH 48 which is shown mechanically coupled to the ground contact spike 56. The GCZVI SWITCH 48 is above the ground contact spike 56. Power for the GIE survey instrument EMBODIMENT B is provided by BATTERY 76 shown schematically above AINS 20.

The embodiments A and B differ essentially in the placement of the AINS 20 on the survey pole 50. While signals from the GNSS receiver 62 are valid and available, the distance between the GNSS antenna phase center and the ground contact spike 56 tip on the ground is used for the distance l̅_{AB}^{b} in the coordinate transfer for both EMBODIMENT A and B. If the GNSS signal is determined to be invalid or missing, EMBODIMENT A uses the distance from the inertial center in the IMU to the ground contact spike 56 tip for the length l̅_{AB}^{b} which is a distance near the length of the survey pole 50. In the case of EMBODIMENT B, on loss of the GNSS signal, the distance used for l̅_{AB}^{b} is the distance from the inertial center in the IMU (not shown) to the tip of the ground contact spike 56. FIG. 3b shows that the distance l̅_{AB}^{b} is much shorter than is the case for EMBODIMENT A which would tend to further reduce small errors in the required transfer of coordinates from the inertial center to the tip of the spike during outages. The inertial center of the AINS 20 is defined to be the point at which the accelerometer input axes within the IMU intersect. Embodiments A and B each have particular performance and functional advantages and disadvantages, hence both are considered equally important.

Both embodiments A and B are operated in the same way. When the GIE Survey Instrument has access to a sufficient number of GNSS satellites, then it computes an inertial-aided RTK solution of the inertial center of the AINS 20 using an AINS 20 algorithm described previously. When the instrument is denied the GNSS signal access needed to compute a precise survey-grade position, it reverts to a managed traverse mode during which the operator manipulates the instrument like a walking stick as described in U.S. Pat. No. 6,853,909 to obtain periodic zero-velocity updates (ZUPT) that the AINS uses to regulate its position and orientation errors.

In either the GNSS supported mode or the GNSS-denied walking stick mode, the invention Enhanced Survey Instrument preferably uses a GIE survey instrument to transfer the position solution from the position-transducer 54 to the tip of the ground contact spike 56. The operator surveys a point on the ground by placing the ground contact spike onto the point and directing the GIE Survey Instrument to record its computed position by means such as a manually operated command switch, a spike contact or GCZVI switch, a deceleration detection switch, or a manual or automatic ground velocity monitoring algorithm. The sensitivity of the accuracy of the GIE Survey Instrument to changes in orientation and to motion of the GIE Survey Instrument during the data acquisition phase of a survey is substantially reduced by the accuracy of the automatic three-dimensional position transfer during dynamic motion and the elimination of the need to have the surveyor manually erect the survey pole 50 into a vertical position for each position measurement.

Physical Properties of the GIE Survey Instruments

Referring now to FIGS. 3a and 3b, the survey pole 50 in each case is typically an assembly that comprises an UPPER POLE 88, a lock 90, a handgrip 92, an optional bubble level 94, and a lower survey pole 96. The survey pole 50 is a standard item that can be obtained from a supplier of survey equipment. The upper survey pole 88 telescopes into the lower survey pole 96 and is locked into position with the lock 90 for storage.

Each of the embodiments A and B has a navigational computer function distributed in the modules that comprise the GIE Survey Instruments shown. Each has a computer subsystem. The GNSS receiver 62 receives the radio frequency (RF) signal from the GNSS antenna 64 and computes either observables for each tracked satellite (pseudorange, carrier phase, ephemeris parameters) or a GNSS navigation solution (position in geodetic coordinates). In EMBODIMENT A of FIG. 3a, the navigation computer system (NCS) (not shown) and GNSS receiver 62 are located inside the GNSS-INS module 60 to reduce the number of hardware components. In EMBODIMENT B of FIG. 3b, the GNSS receiver 62 is located inside the GNSS module 70 and the NCS is located inside the AINS-GCI switch module 72.

A control and data unit (CDU) (also not shown) displays and records data from the GIE survey instruments for the surveyor to view, and receives control signals from the surveyor to the GIE survey instrument. External displays linked by cables, RF or IR links provide this function. One or more power modules (not shown) provide batteries such as BATTERY units 68 and 76 and power management electronics for powering the components of the respective EMBODIMENTS A or B. A data and power wire harness (not shown) provides the electrical interface between the CDU, power module and the internal navigational computer. In the preferred embodiment, the CDU is attached to the survey pole 50, and the power modules are embedded in the GNSS module 70 and AINS-GCI switch module 72. In alternative embodiments, these components can be carried by the surveyor in a belt or backpack.

The GNSS antenna 64 is mounted on the top of the GNSS receiver 62 at the survey pole top end 58 of survey pole 50. When the survey pole 50 is held in its normal vertical position, the GNSS antenna 64 faces the sky. In FIG. 3b, the AINS-GCI module 72 is mounted on the survey pole bottom end 52, so that the IMU within the AINS 20 is close to the ground when the survey pole 50 is held in its normal vertical position.

The GNSS receiver 62 has electronics that are be collocated with the GNSS antenna 64. The GNSS receiver 62 receives the radio frequency (RF) signal from the GNSS antenna 64 and computes observables for each tracked satellite comprising pseudorange, carrier phase, ephemeris parameters and possibly a GNSS navigation solution comprising position in geodetic coordinates. The navigation computer system (NCS) contains a computer subsystem that performs the AINS data processing. Alternatively, the NCS can be located in the GNSS-INS module in embodiment A or the AINS-GCI switch module in embodiment B.

The GNSS receiver in each of the embodiments A and B computes a precise GNSS position using GNSS correction signals. In one embodiment, the correction signals come from a single GNSS reference receiver at a precisely known location via a communication channel such as a radio modem or a cellular telephone network. In another embodiment, the correction signals come from a virtual reference station (VRS) system such as that described in U.S. Pat. No. 6,324,473 to Eschenbach (hereinafter “Eschenbach”); in U.S. Patent application publication no. 2005/0064878, of B. O'Meagher (hereinafter “O'Meagher”); and in a paper by H. Landau et al. titled “Virtual Reference Stations versus Broadcast Solutions in Network RTK” published in the GNSS 2003 Proceedings of a conference at Graz, Austria (2003). In another embodiment, the correction signals come from a satellite-based augmentation system (SBAS), and the GNSS receiver computes a precise point position solution. One example of this type of real-time precise point positioning SBAS is the Omnistar HP service provided by Fugro N.V.

Rie Survey Instrument

FIGS. 4a and 4b show alternative embodiments of a standard RTS Inertial Enhanced (RIE) survey instrument respectively as EMBODIMENT C and D of the invention. EMBODIMENT C as shown in FIG. 4a has an RTSR-INS module 84 at the survey pole top end 58 of survey pole 50. The RTSR-INS module 84 comprises an AINS 20 and an RTSR module 80 in the same package. The RTSR module 80 uses a retro-reflector prism 86 to return a laser beam to a robotic total station (RTS).

EMBODIMENT D of FIG. 4b has an RTSR module 80 at the survey pole top end 58. The AINS 20 is moved to the survey pole bottom end 52 where it is positioned above the GCZVI SWITCH 48. The GCZVI SWITCH 48 is above the ground contact spike 56. The RTSR module 80 in EMBODIMENTS C and D uses the retro-reflector prism 86 to return a laser beam from the RTS 46 to the RTS 46 shown on FIG. 2c. Returning to FIGS. 4a and 4b, the GCZVI switch 48 is shown at the survey pole bottom end 52 for both EMBODIMENT C and D. An interface (cable harness or wireless coupler) coupling means between the GCZVI switch 48 and the RTSR-INS module 84 of FIG. 4a or the RTSR module 80 of FIG. 4b is not shown.

The RIE survey instruments of FIGS. 4a and 4b differs from the GIE survey instruments of FIGS. 3a and 3b in that the GIE systems of FIGS. 3a and 3b each have a GNSS receiver 62 that is replaced by the RTS retro-reflector (RTSR) module 80 in each RIE system. The RTSR module 80 uses a retro-reflector or prism 86 to reflect a laser beam (not shown) from the retro-reflector prism 86 back to an RTS receiver or transponder such as RTS receiver 46 shown in FIG. 2c. The reflected laser beam serves as a means of measurement and a means for coupling data from the RTSR module 80 to the RTS receiver 46, and/or from the RTS receiver 46 to the RTSR module 80. The RTS receiver 46 provides the required laser source and measures the relative position of the RTSR module 80 with respect to the RTS receiver 46 by measuring azimuth angle, inclination angle and range of the RTS receiver 46 to the retro-reflector prism 86 within the RTSR module 80. The RIE survey system computes the position of the retro-reflector prism 86 as that of the position-transducer 54. The computation is performed at the RTSR module 80 or at the RTS receiver 46 because the laser beam that is used to make the measurement also provides a convenient means for data linking the RTSR module 80 with the RTS receiver 46.

The embodiments C and D differ from each other only in the location of the AINS. Both embodiments are operated in the same way. When the RTS module 80 has access to the RTS laser beam, the RTS module 80 uses the position data supplied by the RTS 46 to compute the precise position of the retro-reflector prism 86, which is treated as the position of the position transducer 54 in FIG. 2c. The RTS module 80 then uses the position data and the Euler angle data from the AINS to compute the offset vectors shown in FIG. 2c. The offset vectors are then added to the transducer position data to obtain the position on the ground of spike 56. The position of the spike is then used by the Kalman filter as measurement data with which to update the position of the AINS as well as the position data log for the survey.

The AINS in turn computes an accurate orientation solution that the instrument, the RTS module 80, or the AINS, uses to perform a position transfer to the ground contact point (GCP) i.e. location B on FIG. 2c during a survey. When the laser beam from the RTS is blocked by an obstruction between the RTS and the retro-reflector prism 86, the instrument reverts to the managed traverse mode described in the previous section. In either mode, the RIE survey instrument performs a transfer of position to the GCP at position B without requiring the surveyor to manually position the survey pole 50 into a vertical position.

Physical Properties of the RIE Survey Instrument

The survey pole 50 of FIGS. 4a and 4b is typically an assembly that comprises an UPPER POLE 88, a lock 90, a handgrip 92, an optional bubble level 94, and a lower survey pole 96. The survey pole 50 is a standard item that can be obtained from a supplier of survey equipment. The upper survey pole 88 telescopes into the lower survey pole 96 and is locked into position with the lock 90 for storage.

Each of the embodiments C and D has a navigational computer function distributed in the modules that comprise the RIE Survey Instruments shown. Each has a computer subsystem. In EMBODIMENT C of FIG. 4a, the navigation computer system (NCS) (not shown) and the RTSR module 80 are located inside the RTSR-INS module 84 to reduce the number of hardware components.

In EMBODIMENT D of FIG. 4b, the NCS is located inside the AINS-GCI switch module 72. The retro-reflector prism 86 and the RTSR module 80 are mounted on the survey pole top end 58 at the top of the survey pole 50. When the survey pole 50 is held in its normal vertical position, the retro-reflector prism 86 is high enough so that the surveyor does not obstruct the line of sight between the RTS and the retro-reflector prism 86. The survey pole top end 58 typically has a coarse threaded stud to which the RTSR module 80 with the retro-reflector prism 86 therein is attached.

As in the case of the GIE instruments of EMBODIMENTS A and B, the control and data unit (CDU) (not shown) displays and records data from the RIE survey instrument of EMBODIMENTS C and D for the surveyor to view, and receives control signals from the surveyor to the RIE survey instrument. One or more power modules such as batteries 68 and 74 appear on the drawings as examples only. A data and power wire harness (not shown) provides the electrical interface between the CDU, power module and the NCS. In the preferred embodiment, the CDU is attached to the survey pole 50, and power modules are embedded in the RTSR module 80 and AINS-GCI switch module 72. In alternative embodiments, components are or can be carried by the surveyor in a belt or backpack. In FIG. 4b, the AINS 20 package contains the IMU 26 and the INERTIAL NAVIGATOR 28 as shown in FIG. 1 in the AINS-GCI module 72 enclosure that is mounted on the bottom end of the shaft, so that the IMU 26 is close to the ground when the survey pole 50 is held in its normal vertical position.

The NCS is a computer subsystem that performs the AINS data processing. Alternatively the computer subsystem can be located in the RTSR-INS module 84 in EMBODIMENT C or the AINS-GCI switch module 72 in embodiment D.

### PREFERRED EMBODIMENT AND ADVANTAGE

The preferred embodiment of the invention is an AINS enhanced survey instrument in which the AINS is available on the survey pole 50 and provides the orientation solution used to provide tilt compensation as a by-product. Examples are the GIE survey instrument and the RIE survey instrument, both described above.

The invention thus disclosed eliminates the requirement for the surveyor to precisely level the survey pole 50 and hold it stationary before acquiring survey data.

The surveyor therefore needs only to place the ground contact spike onto the point to be surveyed to immediately acquire the surveyed position for that point. The process taught herein eliminates the 10-30 seconds required to level the survey pole 50, and thereby reduces the time spent on each survey point down to the minimum occupation time required by the survey instrument.

In addition, the invention-provides continuous position information when the position transducer 54 is unable to provide normal position information. In the case of the GIE survey instrument, the causes of position information failures include satellite signal obstruction, signal reflections and refractions (commonly called multi-path error), reference receiver data stream outages and atmospheric disturbances. In the case of the RIE survey instrument, the causes of position information failures include laser line-of-sight obstruction, weak laser return due to excessive range or signal absorption (typically due to smoke, dust or haze), and RTSR module 80 data link outages to the RTS 46 receiver 46. The invention provides the managed traverse capability of the WSN which provides continuous position information during these primary position transducer failures.

Position Coordinate Transfer

The orientation angles of the IMU 26 as computed by the INERTIAL NAVIGATOR 28 is used as data in the computation of the vectors of FIGS. 2a-2c to perform a position coordinate transfer from the position-transducer 54 location at survey pole top end 58 to another point, such as location B, whose lever arm vector with respect to the position-transducer 54 is known.

FIG. 2a shows the geometry of a position transfer on a survey instrument where the position-transducer 54 is a GNSS receiver 62. The known lever arm vector l̅_{AB}^{b} is resolved in a coordinate frame fixed to the instrument. In the example of FIG. 2a, the lever arm l̅_{AB}^{b} from the position-transducer 54 location A to the GCP B is resolved in a body coordinate frame fixed to the survey pole 50 with the z-axis pointing down and the x and y axes aligned with the horizontal input axes of the IMU attached to the survey pole 50 with reference to H or to a ground referenced terrestrial frame in latitude and longitude.

The known lever arm resolved in the survey instrument body coordinate frame is given by

$${\overline{l}}_{AB}^{b} = [ \begin{matrix}0 \\ 0 \\ {l}_{AB}\end{matrix} ] \qquad ( 1 )$$

where l̅_{AB}^{b} is the separation between the position-transducer 54 location A and the GCP B is known by measurement or factory calibration. The AINS measures the roll φ, pitch θ and heading ψ of the survey instrument with respect to the North, East and Down directions. The position-transducer 54 computes the position coordinates of location A in terms of latitude λA, longitude LA and altitude h A with respect to a terrestrial reference frame, or with respect to a grid coordinate frame in terms of Northing λNA, Easting ΔEA and height ΔZA or Down with respect to an arbitrary or known reference position as is shown in FIG. 2a.

The relative position of B with respect to A resolved in the North-East-Down coordinate frame is the lever arm vector in North-East-Down coordinates, given by

$$[ \begin{matrix}Δ {r}_{N} \\ Δ {r}_{E} \\ Δ {r}_{D}\end{matrix} ] = {\overline{l}}_{AB}^{NED} = {C}_{b}^{NED} {\overline{l}}_{AB}^{b} \qquad ( 2 )$$

where C_{b}^{NED} is a direction cosine matrix (DCM) given by

$${C}_{b}^{NED} = [ \begin{matrix}cos ψ & - sin ψ & 0 \\ sin ψ & cos ψ & 0 \\ 0 & 0 & 1\end{matrix} ] [ \begin{matrix}cos θ & 0 & sin θ \\ 0 & 1 & 0 \\ - sin θ & 0 & cos θ\end{matrix} ] [ \begin{matrix}1 & 0 & 0 \\ 0 & cos φ & - sin φ \\ 0 & sin φ & cos φ\end{matrix} ] \qquad ( 3 )$$

The position coordinate transfer in terms of latitude, longitude and altitude is then given by

$${λ}_{B} = {λ}_{A} + \frac{Δ {r}_{N}}{{r}_{e}} \qquad ( 4 )$$

$${L}_{B} = {L}_{A} + \frac{Δ {r}_{E}}{{r}_{e} cos {λ}_{a}} \qquad ( 5 )$$

h_{B}=h_{A}−Δr_{D} (6)

where rₑ is the equatorial radius of the earth (6,378,137 meters). These equations assume a spherical earth and hence are approximate. The approximation error is on the order of fractions of a millimeter and hence is negligible.

The position coordinate transfer in terms with respect to a North-East-Vertical grid coordinate frame is

ΔNB=ΔNA+ΔrN (7)

ΔEB=ΔEA+ΔrE (8)

ΔZB=ΔZA−ΔArD (9)

These equations are hereafter referred to collectively as the position transfer equations.

Operation

Table 1. below provides a sequence of events in flow table format that describes the invention operation.

TABLE 1

| Step | Operator Action | Survey instrument Action |
|---|---|---|
| 1 | The operator powers up the | The survey instrument performs the |
| | survey instrument and waits for | following internal initializations: |
| | its initialization to complete. | position-transducer 54 initialization |
| | | GNSS satellite acquisition followed by |
| | | position fixes and RTK initialization, or |
| | | RTS seek and lock |
| | | AINS alignment and initialization |
| | | Upon completion of the initialization |
| | | steps, the survey instrument signals the |
| | | operator via its CDU (not shown) that it is |
| | | fully operational and available to Start. |
| 2 | The operator enters initialization | The survey instrument receives and stores |
| | data via the CDU that can | these data items. |
| | include the following: | |
| | survey pole length | |
| | data acquisition mode | |
| | (INSTANTANEOUS or | |
| | AVERAGED) | |
| 3 | The operator carries the survey | The survey instrument runs the position- |
| | instrument to a point to be | transducer 54 and AINS. The position- |
| | surveyed, and initiates a Start | transducer system generates position fixes |
| | command. | every sample interval Δtpt, to be typically |
| | | in the range 0.1 to 1 second. The AINS |
| | | uses these position fixes to improve its |
| | | alignment and navigation accuracies. |
| 4 | The operator places the ground | The survey instrument detects contact |
| | spike on the ground point to be | with the ground via its GCZVI switch 48, |
| | surveyed. The operator holds the | and signals the operator via the CDU that |
| | survey instrument approximately | ground contact has been established. |
| | but not exactly level, mainly to | |
| | ensure that the position- | |
| | transducer 54 is oriented | |
| | correctly. | |
| 5 | The operator directs the survey | The survey instrument performs the |
| | instrument to acquire the GCP. | following actions: |
| | | It internally acquires the next time- |
| | | synchronized position-transducer 54 |
| | | solution and AINS navigation solution |
| | | after receiving the signal. |
| | | It computes the position change vector |
| | | from the position-transducer 54 to the |
| | | GCP using equations (1) to (3). |
| | | The survey instrument computes the GCP |
| | | in the required coordinates. Equations (4) |
| | | to (6) generate geographic coordinates. |
| | | Equations (7) to (9) generate grid |
| | | coordinates. |
| | | If the data acquisition mode is |
| | | AVERAGED, it repeats the above steps |
| | | every Δtpt and averages the instantaneous |
| | | position positions so long as the GCZVI |
| | | switch is closed, or: |
| | | if the data acquisition mode is |
| | | INSTANTANEOUS, it performs the |
| | | above steps once following the operator |
| | | command to acquire data. It immediately |
| | | saves the GCP coordinates to non-volatile |
| | | memory. |
| 6 | The operator lifts the survey instrument. | If in AVERAGED mode, the survey |
| | | instrument saves the averaged GCP |
| | | coordinates to non-volatile memory. |
| 7 | The operator repeats the above | The survey instrument repeats the above |
| | Steps 3-6 for the next point to be | Steps 3-6. |
| | surveyed. | |

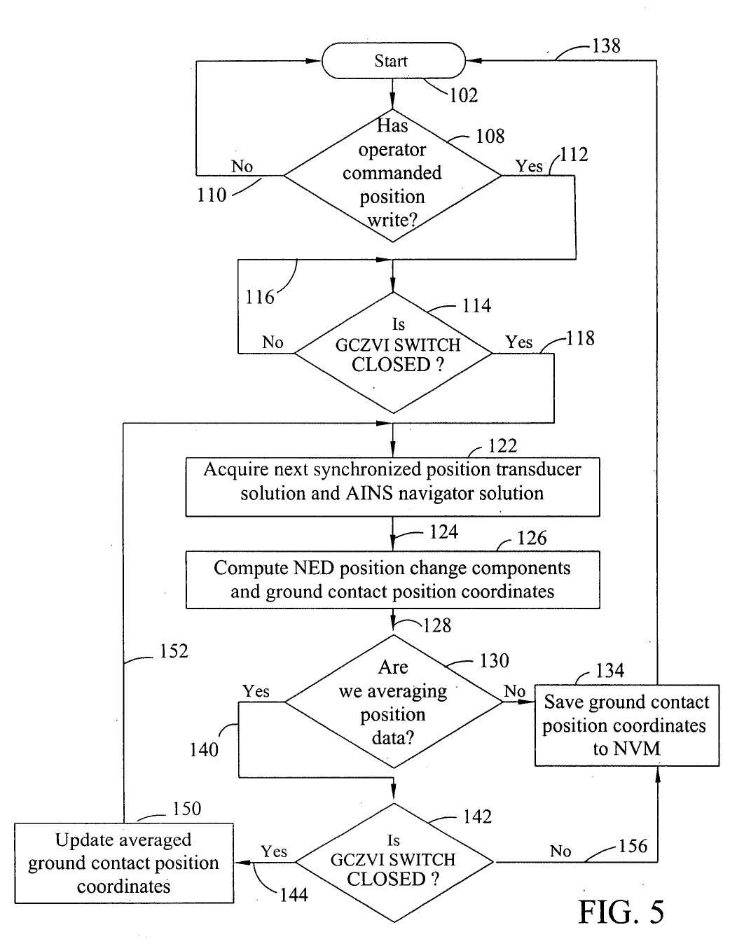

FIG. 5 is a flow chart that begins at the Start Cell 102. The program is normally in a wait loop in which it passes from the Start Cell 102 to decision block 108 where it determines if the surveyor has commanded the position-transducer 54 to make a position measurement. If the operator has not commanded a position measurement, the program loops via branch 110 back to the Start Cell 102 and again enters the decision block 108. If the system detects that the surveyor has requested a position measurement from the position-transducer 54, the program advances to the right via path 112 to decision block 114 where the system holds its state until the GCZVI switch 48 is closed. If the GCZVI switch is already closed, then the position transfer algorithm does not enter the wait loop.

While the GCZVI switch 48 is open, the system follows the path to the left via path 116 to re-enter decision block 114. When the GCZVI switch is determined to be closed, the system advances via path 118 to block 122 where the system is directed to stack the next available synchronized position measurement from the position-transducer 54 along with the values of the Euler angles and the heading of the survey pole 50 and the AINS position measurement and navigational solution.

Time synchronization is implemented as follows. If the AINS-IMU is synchronized to the position-transducer 54 sampling epoch, then synchronization is automatic. If the AINS-IMU and position-transducer 54 are not synchronized, then synchronization is achieved by interpolating two AINS navigation solution records at sample times before and after the position-transducer 54 sample time.

After acquiring and storing or stacking the required data, the program advances via path 124 to block 126 where the system computes the NED position change components and GCP coordinates at the spike using equations (1) to (3) and the GCP coordinates. The computed offset corrections are presented in both great circle angle and in linear distance increments using equations (4) to (6) to generate the geographic coordinate changes in angle, and equations (7) to generate the grid distance coordinate changes.

The flow chart of FIG. 5 shows that the process then advances via path 128 to decision block 130 where the program determines if the surveyor had commanded the INSTANTANEOUS or the AVERAGED MODE. If the AVERAGED MODE is not selected, the process advances from block 130 via the right via path 132 to block 134 where the program saves or stacks the GCP coordinates that were calculated in non-volatile memory. After saving the GCP coordinates, the process advances via path 138 back to the Start Cell 102.

If a determination is made at decision block 130 that the surveyor has selected the AVERAGED MODE then the program branches to the left via path 140 and down to decision block 142 where the process determines if the GCZVI switch 48 is closed. If the GCZVI switch 48 is closed, the process advances to the left along the YES path 144 to block 150 where the program updates the averaged GCP coordinates. If there had been previous values stored, the average of the position values are computed for use on the next pass. After computing the average position of the spike, and storing the same, at block 150, the program advances along path 152 back to block 122 to sample and acquire the next position reading from the position-transducer 54 and from the AINS for accumulation and averaging as the program again circulates down through blocks 126 to again reach decision block 142 until a determination is made that the GCZVI switch 48 is open. Once the determination is made that the GCZVI switch 48 is open, the program passes through block 142 to the right along the YES path 156 back to block 134 where the program saves the computed value of the GCP coordinates to non-volatile memory before returning to the Start Cell 102 via path 138.

If the operator or surveyor has selected an AVERAGED mode, the position transfer algorithm acquires time-synchronized position-transducer positions while the GCZVI switch 48 is closed in block 142, and an AINS navigation solution is acquired for every position-transducer epoch during that interval, The position algorithm continuously computes the instantaneous GCP coordinates and updates the running averages of those calculated components. Averaging reduces random errors and improves the accuracy of the calculated coordinates. The GCP coordinates are ideally the same at every sampling epoch and differ at the conclusion of epochs only by slight position errors. Averaging reduces the errors even further. The averaging time ends when the GCZVI switch 48 opens. The survey instrument software then saves the averaged GCP coordinates to non-volatile memory as a function of block 134. It is an advantage of the invention system that the surveyor does not have to keep the survey pole 50 perfectly still during the period that the present GCZVI switch 48 remains closed and the GCP coordinates are being captured from the position-transducer 54 and/or the AINS. Small variations in the orthogonality of the survey pole 50 with respect to a locally level plane or variations in the heading of the survey pole 50 are detected by the AINS during their occurrence and the resulting Euler angles and heading values are used to produce accurate offset corrections to the position of the position-transducer 54 or the AINS with respect to the GCZVI switch 48 and the spike without drawing the attention or concern of the surveyor. The position transfer algorithm thereby removes a potential error source that attends the use of current GNSS or RTS survey instruments.

In FIGS. 3a-4b, the GIE and the RIE embodiments are shown in their normal vertical position. A position vector called the IMU to Ground Reference lever arm (IGRLA) vector (not shown) extends from an origin within the IMU enclosure 61 or the AINS 41 to the ground. The IMU in the INS enclosure 61 is rigidly attached to the survey pole 50. The IGRLA vector describes the relative position of the IMU with respect to the tip of the ground spike in IMU or b-frame coordinates. The IMU or b-frame is fixed to the survey pole 50 therefore the IGRLA vector is fixed, measurable and hence, known to the GIE and the RIE system processing software as is the vector from the position-transducer to the ground spike l̅_{AB}^{b}.

When GNSS data is available, the surveyor simply carries the GIE system as he would a GNSS survey instrument. The GIE runs a GNSS-aided INS algorithm as shown in FIG. 1 to compute a blended navigation solution and improve on the INS alignment. This is classical AINS operation as described in numerous references such as in Aerospace Avionics Systems, A Modern Synthesis, George Siouris, Academic Press 1993.

On the loss of the GNSS data due to signal shading, as in forests, tunnels and inside buildings, the surveyor manipulates the GIE like a walking stick. The GIE runs an AINS algorithm to control the position error drift during dead-reckoning navigation that uses relative displacements of the IMU 26 within the AINS system 20 shown in FIG. 1. The GIE software uses the AINS or INS position data and calculated the offset distances using equations 3-9 using the outputs of the INS, the knowledge of the IGRLA vector (not shown) and the closure of the GCZVI switch 48 to correct velocity errors.

Those skilled in the art will appreciate that various adaptations and modifications of the preferred embodiments can be configured without departing from the scope and spirit of the invention. Therefore, it is to be understood that the invention may be practiced other than as specifically described herein, within the scope of the appended claims.

1. An aided inertial navigation system (AINS) enhanced precision land survey instrument comprising:
a survey pole having a survey pole top end and a survey pole bottom end,
a position-transducer fixed to the survey pole at a predetermined location, on the pole, a distance between the position transducer and the survey pole bottom end, the position transducer providing
a sequence of earth referenced position signals that characterize the earth referenced position of the position transducer,
a ground contact zero velocity indicator (GCZVI) switch module coupled to the survey pole bottom end to provide
a zero velocity signal when the survey pole bottom end is in contact with the ground,
an AINS rigidly coupled to the survey pole, the AINS supplying roll, pitch and heading signals of the survey pole with respect to a ground referenced locally level coordinate system that characterize the tilt and heading of the survey pole,
a computer and program means responsive to the roll, pitch and heading signals, the zero velocity signal and the predetermined distance from the position-transducer to the survey pole bottom end for calculating and adding North, East and Down vectors in an earth referenced locally level co-ordinate system leading from the position of the position transducer to the position of the survey pole bottom end to obtain the earth referenced position of the survey pole bottom end when the survey pole bottom end is in contact with the ground.

2. The AINS enhanced precision land survey instrument of claim 1 wherein the position-transducer is a GNSS receiver and antenna characterized to provide the earth referenced position signals characterizing the earth referenced position of the GNSS antenna.

3. The AINS enhanced precision land survey instrument of claim 2 wherein the AINS coupled to the survey pole for supplying roll, pitch and heading signals that characterize the tilt and heading of the survey pole is integrated into a package within the GNSS receiver and antenna at the survey pole top end.

4. The AINS enhanced precision land survey instrument of claim 2 wherein the AINS coupled to the survey pole for supplying roll, pitch and heading signals that characterize the tilt and heading of the survey pole is integrated into a package coupled to the survey pole adjacent to its bottom end.

5. The AINS enhanced precision land survey instrument of claim 2 wherein the GNSS receiver and antenna at the survey pole top end is augmented to employ a precise point positioning algorithm for enhanced accuracy.

6. The AINS enhanced precision land survey instrument of claim 5 wherein the precise point positioning algorithm for enhanced accuracy uses data obtained from a space based augmentation subscription service.

7. The AINS enhanced precision land survey instrument of claim 1 wherein the position-transducer is a reflective prism and data receiver for use with a CTS or an RTS receiver or transponder, each being characterized to provide the measured earth referenced position of the position-transducer based on the known position of the RTS receiver or transponder.

8. The AINS enhanced precision land survey instrument of claim 7 wherein the AINS coupled to the survey pole supplying roll, pitch and heading signals that characterize the tilt and heading of the survey pole is integrated into a package within or adjacent to the GCZVI switch module adjacent to the survey pole bottom end.

9. The AINS enhanced precision land survey instrument of claim 2 wherein the AINS has a position center typically characterized as the intersection of the accelerometer axis, and wherein the program for calculating the earth referenced position of the survey pole bottom end corrects the position of survey pole bottom end for a lever arm distance between the survey pole bottom end and the AINS position center to provide a sequence of corrected positions of the AINS position center, the corrected position of the AINS position center being coupled to the AINS for use by the AINS Kalman filter to continually enhance AINS computed present position for use in response to interruption of position transducer position data, the sequence of computed positions of the survey pole bottom ends being supplied to the AINS Kalman filter to provide continuing updated position data to the AINS enabling the AINS to provide dead reckoning navigational data for uninterrupted performance of the AINS enhanced precision land survey instrument in response to loss of position transducer position data.

10. An AINS enhanced precision land survey instrument systems comprising:
a survey pole having
a survey pole top end and
a survey pole bottom end,
a position-transducer fixed to the survey pole at
a predetermined location, the predetermined location being adjacent the survey pole top end,
the position transducer having a robotic total station retro-reflector (RTSR) for receiving and returning
a laser beam from a robotic total station (RTS) receiver at a known earth based position, the RTS receiver measuring the ground referenced position of the RTSR by measuring the distance, bearing and elevation of the RTSR at the survey pole top end with respect to the known ground position of the RTS receiver from data obtained from the returned laser beam provided by the RTS receiver,
the RTS calculating North, East and Down vectors from the ground referenced locally level position of the RTS to the ground referenced and locally level position of the RTSR and adding the calculated vectors to the earth referenced position of the known position of the RTS to obtain the earth referenced position of the RTSR based on the known earth referenced position of the RTS,
a GCZVI switch coupled to the survey pole bottom end to provide
a zero velocity signal when the survey pole bottom end is in contact with the ground,
the survey pole having a predetermined distance from the position transducer to the survey pole bottom end,
an AINS rigidly coupled to the survey pole, the AINS supplying roll, pitch and heading signals of the pole with respect to a ground referenced locally level coordinate system that characterizes the tilt and heading of the survey pole, a computer and program responsive to the roll, pitch and heading signals of the pole, the zero velocity signal and predetermined distance from the position transducer to the survey pole bottom end for calculating and adding North, East and Down vectors in the earth referenced locally level coordinate system from the position of the RTSR to the position of the survey pole bottom end to obtain the earth referenced position of the survey pole bottom end when the survey pole bottom end is in contact with the ground.

11. The AINS enhanced precision land survey instrument system of claim 10 wherein the AINS supplying roll, pitch and heading signals that characterize the tilt and heading of the survey pole is coupled to the pole adjacent to the a GCZVI switch.

12. The AINS enhanced precision land survey instrument system of claim 10 wherein the AINS has a position center typically characterized as the intersection of the accelerometer axis, and wherein the program for calculating the earth referenced position of the survey pole bottom end corrects the position of the survey pole bottom end for a lever arm distance between the survey pole bottom end and the AINS position center to provide a corrected position of the AINS position center, the corrected position of the AINS position center being coupled to the AINS for use by the Kalman filter to continually enhance AINS computed present position.

13. The AINS enhanced precision land survey instrument system of claim 10 wherein the AINS coupled to the survey pole for supplying roll, pitch and heading signals that characterize the tilt and heading of the survey pole is further characterized as being positioned on the survey pole immediately above
a spike positioned at the survey pole bottom end, the GCZVI switch being integrated within the AINS into a common package.

14. An AINS enhanced precision land survey instrument system process comprising the steps of:
1. rigidly coupling a position transducer to a survey pole,
2. rigidly coupling a package containing an AINS with a the GCZVI switch to a survey pole, the survey pole having
a bottom end protected by a spike for contact with a survey point on the ground,
3. obtaining the earth referenced position of the position-transducer
4. obtaining roll, pitch and heading angles of the survey pole from the AINS measured with respect to an earth referenced coordinate system,
5. calculating a vector set that characterizes a lever arm vector extending from the position-transducer to the spike using the roll, pitch and heading angles obtained from the AINS,
6. adding the vector set to the position transducer position to obtain the position of the spike on the ground, and
7. outputting the position of the spike on the ground as a surveyed position.

15. The AINS enhanced precision land survey instrument system process of claim 14 wherein the step of calculating a vector set that characterizes a lever arm vector extending from the position-transducer to the spike further comprises:
5A. calculating a vector set comprising a North, East and Down vector components in a ground reference coordinate system extending from the position transducer position to the location of the spike on the ground,

16. The AINS enhanced precision land survey instrument system process of claim 14 further comprising the steps of:
1. selecting the position transducer to be a GNSS receiver and antenna characterized to provide the earth referenced position of the GNSS antenna, and
2. using the position transducer position data to continually update an input to a Kalman Filter aiding input for the AINS.

17. The AINS enhanced precision land survey instrument system process of claim 14 further comprising the steps of:
selecting the position-transducer to be an RTSR cooperating with a ground referenced RTS to provide the position of the position transducer, and
using the position transducer position data to continually update a position data input to a Kalman Filter aiding input for the AINS.

18. The AINS enhanced precision land survey instrument system process of claim 15 wherein the step of selecting the position transducer to be a GNSS receiver and antenna further includes the step of:
positioning the GNSS receiver and antenna to be at the survey pole top end, and
further comprises the step of augmenting the GNSS receiver and antenna to employ
a precise point positioning algorithm for enhanced accuracy without employing additional ground based receivers.

19. The AINS enhanced precision land survey instrument system process of claim 17 further comprising the step of automating the precise point positioning algorithm for enhanced accuracy to use data obtained from a space based augmentation subscription service.

20. An aided inertial navigation system (AINS) enhanced precision land survey instrument, comprising:
a survey pole having a top end and a bottom end,
a position-transducer fixed to the survey pole at known location relative to the bottom end, the position transducer providing a sequence of earth referenced position signals that characterize the earth referenced position of the position-transducer,
a switch coupled to the survey pole to provide a switch signal when the survey pole bottom end is at a point to be surveyed,
an AINS coupled to the survey pole, the AINS supplying tilt and heading signals of the survey pole that characterize the tilt and heading of the survey pole with respect to a ground referenced locally level coordinate system,
a computation unit, responsive to the tilt and heading signals, the switch signal and known location of the position-transducer relative to the survey pole bottom end, for calculating coordinate translation information in an earth referenced locally level co-ordinate system leading from the position of the position transducer to the position of the survey pole bottom end to obtain the earth referenced position of the survey point.

21. The AINS enhanced precision land survey instrument of claim 20, wherein the switch is a ground contact zero velocity indicator switch at the bottom end of the survey pole.

22. The AINS enhanced precision land survey instrument of claim 20, wherein the position-transducer is a GNSS receiver and antenna characterized to provide each referenced position signals characterizing the earth referenced position of the GNSS antenna.

23. The AINS enhanced precision land survey instrument of claim 20, wherein the position-transducer and AINS is located at the survey pole top end.

24. The AINS enhanced precision land survey instrument of claim 20, wherein the position-transducer and AINS is integrated into a single package at the survey pole top end.

25. The AINS enhanced precision land survey instrument of claim 20, wherein the AINS is located next to the survey pole bottom end.

26. The AINS enhanced precision land survey instrument of claim 22, wherein the GNSS receiver receives augmented correction signals from a ground GNSS reference receiver.

27. The AINS enhanced precision land survey instrument of claim 20, wherein the position-transducer comprises a reflective prism and data receiver for use with one of a CTS or an RTS receiver or transponder, which provides measured earth referenced position of the position-transducer.

28. The AINS enhanced precision land survey instrument of claim 20 wherein the AINS has a position center and wherein the computation unit calculates the earth referenced position of the survey pole bottom end and corrects the position of survey pole bottom end for a lever arm distance between the survey pole bottom end and the AINS position center to provide a sequence of corrected positions of the AINS poison center, wherein the AINS has a Kalman Filter, and wherein the corrected position of the AINS position center is coupled to the AINS for use by the AINS Kalman Filter to continually enhance AINS computed present position for use in response to interruption of receipt of position transducer position data, and wherein the sequence of computed positions of the survey pole bottom ends are supplied to the AINS Kalman Filter to provide continuing updated position data to the AINS enabling the AINS to provide dead reckoning navigational data for uninterrupted performance of the AINS enhanced precision land survey instrument in response to interruption of position transducer position data.

29. An AINS enhanced precision land survey instrument systems comprising:
a survey pole having a top end and a bottom end;
a position-transducer fixed to the survey pole at known location relative to the bottom end, the position transducer having a robotic total station retro-reflector (RTSR) for receiving and returning a laser beam from a robotic total station (RTS) receiver at a known earth based position, the RTS receiver measuring the ground referenced position of the RTSR by measuring the distance, bearing and elevation of the RTSR at the survey pole top end with respect to the known ground position of the RTS receiver from data obtained from the returned laser beam provided by the RTS receiver, the RTS calculating coordinate transformation information from the ground referenced locally level position of the RTS to the ground referenced and locally level position of the RTSR, and calculating the earth referenced position of the RTSR based on the known earth referenced position of the RTS and the coordinate transformation information;
a switch coupled to the survey pole to provide a switch signal when the survey pole bottom end is at a point to be surveyed;
an AINS coupled to the survey pole, the AINS supplying tilt and heading signals of the pole with respect to a ground referenced locally level coordinate system that characterizes the tilt and heading of the survey pole, a computation unit responsive to the tilt and heading signals of the pole, the switch signal and the known location of the position-transducer relative to the survey pole bottom end for calculating, from the coordinate transformation information and the position of the RTSR, the earth referenced position of the survey point.

30. The AINS enhanced precision land survey instrument system of claim 29, wherein the AINS is coupled to the pole adjacent to the switch.

31. The AINS enhanced precision land survey instrument system of claim 29, wherein the switch is a ground contact zero velocity indicator (GCZVI) switch at the bottom end.

32. The AINS enhanced precision land survey instrument system of claim 29, wherein the AINS has a position center, wherein the AINS has a Kalman Filter, and wherein the computation unit for calculating the earth referenced position of the survey pole bottom end corrects the position of the survey pole bottom end for a lever arm distance between the survey pole bottom end and the AINS position center to provide a corrected position of the AINS position center, the corrected position of the AINS position center being coupled to the AINS for use by the Kalman Filter to continually enhance AINS computed present

33. The AINS enhanced precision land survey instrument system of claim 29 wherein the AINS is positioned next to the bottom end of the survey pole.

34. The AINS enhanced precision land survey instrument system of claim 29, wherein the AINS is integrated with the switch into a common package.

35. An aided inertial navigation system (AINS) enhanced precision land survey instrument system process using a survey pole with a top end and a bottom end, a position-transducer located on the pole at a certain position spaced from the bottom end, and an aided inertial navigation system (AINS), comprising the steps of:
a. locating the bottom end on a survey point;
b. obtaining the earth referenced position of the position-transducer;
c. obtaining tilt and heading angles of the survey pole from the AINS measured with respect to an earth referenced coordinate system;
d. calculating a vector set that characterizes the location of the position-transducer relative to the bottom end using the tilt and heading angles obtained from the AINS;
e. adding the vector set to the position transducer position to obtain the position of the bottom end; and
f. outputting the position of the bottom end on the ground as a surveyed position of the survey point.

36. The AINS enhanced precision land survey instrument system of claim 35, wherein the step of calculating a vector set further comprises:
calculating a vector set comprising North, East and Down vector components in a ground reference coordinate system extending from the position transducer position to the location of the bottom end of the survey pole.

37. The AINS enhanced precision land survey instrument system process of claim 35, wherein the position-transducer is a GNSS receiver and antenna characterized to provide the earth referenced position of the GNSS antenna, and further comprising the step of using the position-transducer position data to continually update an input to a Kalman Filter aiding input for the AINS.

38. The AINS enhanced precision land survey instrument system process of claim 35 wherein the position-transducer is an RTSR cooperating with a ground referenced RTS to provide the position of the position-transducer, and further comprising the step of using the position-transducer position data to continually update a position data input to a Kalman Filter aiding input for the AINS.

39. The AINS enhanced precision land survey instrument system process of claim 35 wherein the position-transducer is a GNSS receiver and antenna positioned at the survey pole top end, and further comprising the step of augmenting the GNSS receiver and antenna to employ a precise point positioning algorithm for enhanced accuracy without employing additional ground based receivers.

40. The AINS enhanced precision land survey instrument system process of claim 38 further comprising the step of automating the precise point positioning algorithm for enhanced accuracy to use data obtained from a space based augmentation subscription service.
